(19) United States
(12) Patent Application Publication
(10) Pub. No.: US 2008/0060901 A1
(43) Pub. Date: Mar. 13, 2008

(54) Thin electromagnetic clutch

(75) Inventor: Shen Zhao, Miyota-machi (JP)

Correspondence Address: BACON & THOMAS, PLLC, 625 SLATERS LANE, FOURTH FLOOR, ALEXANDRIA, VA, 22314, US

(73) Assignee: MINEBEA CO., LTD., Nagano-ken (JP)

(21) Appl. No.: 11/892,981

(22) Filed: Aug. 29, 2007

(30) Foreign Application Priority Data
Sep. 8, 2006 (JP) 2006/244864

(51) Int. Cl. F16D 27/10

(52) U.S. Cl. 192/84.1

(57) ABSTRACT

An electromagnetic clutch comprising a stator yoke, the stator yoke comprising a cylindrical portion with a slant inner surface and an annular base plate portion contiguous at an end thereof perpendicularly to one end of the cylindrical portion with the slant inner surface, a radial section cut from the central axis of said cylindrical portion with the slant inner surface being L-shaped, and a rotor, the rotor comprising an annular plate portion, a truncated inverse circular cone portion contiguous at an end thereof perpendicularly to an inner end of the annular plate portion and having a central circular through hole, and an outer cylindrical portion contiguous at an end thereof perpendicularly to an outer end of the annular plate portion, the rotor covering an upper end side of the cylindrical portion with the slant inner surface of the stator yoke and also covering an electromagnetic coil, the truncated inverse circular cone portion being disposed so as to be loosely fitted inside the cylindrical portion with the slant inner surface.

### BACKGROUND OF THE INVENTION

1. Field of the Invention

The present invention relates to a thin electromagnetic clutch having a reduced axial height.

2. Description of the Prior Art

According to the prior art, in order to reduce the thickness of an electromagnetic clutch, the diameter of a rotor and that of a stator yoke are made large, particularly, the diameter of an inner cylindrical portion of a rotor and that of an inner cylindrical portion of a stator yoke are made large, lest magnetic flux density should become high at opposed surfaces of the inner cylindrical portion of the rotor and the inner cylindrical portion of the stator yoke so that an axial attractive force between them become large. For example, a stator yoke of a U-shaped longitudinal section and a rotor of a U-shaped longitudinal section are combined together in a telescopic fashion, the rotor, a bearing and a support member are disposed side by side in the horizontal direction, and the rotor is supported by the support member through the bearing. A shaft is disposed rotatably in the interior of the support member (see, for example, Patent Literatures 1 to 4). Since the stator yoke and the rotor are assembled in a telescopic fashion, the electromagnetic clutch is reduced in thickness.

[Patent Literature 1]

Japanese Patent Laid-Open Publication No. 314585/2003

[Patent Literature 2]

Japanese Patent Application Laid-Open No. 312680/1996

[Patent Literature 3]

Japanese Patent Application Laid-Open No. 114240/1996

[Patent Literature 4]

Japanese Patent Application Laid-Open No. 304221/1990

[Patent Literature 5]

Japanese Patent Application Laid-Open No. 341466/1994

In the above conventional electromagnetic clutch, in order to reduce the thickness thereof, the diameters of the rotor and the stator yoke, particularly the diameters of the respective inner cylindrical portions, are made large. Since the rotor of a U-shaped longitudinal section and the stator yoke of a like section are combined together in a telescopic fashion, magnetic flux flowing between the opposed surfaces of both inner cylindrical portions are mostly directed to the radial direction and attractive forces between the opposed surfaces are mostly offset, so that axial attractive forces of the two are small.

However, the conventional electromagnetic clutch requires a large-sized bearing between and in parallel with the rotor and the support member, the bearing facing in the axial direction. Besides, a support member for support only is needed inside the bearing and a shaft of a large diameter is needed for supporting an increased load resulting from the increase of the entire diameter.

On the other hand, in the case of a vehicular electromagnetic clutch or the like, there is a restriction on not only the thickness but also the diameter of the electromagnetic clutch. Moreover, the larger the diameter of the electromagnetic clutch, the larger the entire weight, resulting in that the manufacturing cost becomes high and parts connected to the clutch become larger in size.

In case of maintaining the rated clutch capacity and reducing the diameters of the inner cylindrical portions, the area of the facing surfaces between the inner cylinder of the rotor and the inner cylinder of the stator yoke which face each other and form a magnetic path becomes smaller in comparison with that of the outer cylindrical portions, and thus the facing surface area for mutual delivery of magnetic flux in radial direction is insufficient, so that there occurs a considerable magnetic flux flow also in the axial direction. Therefore, axial attractive forces of the two become high and so does the load imposed between the rotor and the stator yoke or imposed on the bearing between the two, with consequent shortening of the bearing life. Further, an additional part other than the bearing is needed between the shaft and the rotor, as well as the stator yoke.

In a conventional clutch having the stator yoke of a U-shaped longitudinal section and the rotor of a like section, the cross-section areas of the cylindrical portions of the stator and the rotor are almost the same from a base connected to an annular plate portion to an open end. Between the facing surfaces from the base to the open end of both cylindrical portions, the entire magnetic flux is continuously delivered from one to the other. In this case, the magnetic flux receiving side is low in magnetic flux density at the open end of the cylindrical portion which only receives magnetic flux from the mating base. The magnetic flux density at the base of the magnetic flux receiving side is high, because the base not only receives magnetic flux from the mating open end of the other cylindrical portion but also receives the magnetic flux successively converged on the way flowing from the open end on the magnetic flux receiving side. On magnetic flux delivering side, the magnetic flux density distribution is the same. The base deliveries a part of the magnetic flux, which flows from the annular plate, to the mating open end, and passes the rest toward the open end on the magnetic flux delivering side along the cylindrical body. Since the rest of magnetic flux is successively delivered to the mating surface on the way reaching the open end on the magnetic flux delivering side, it only receives a part of the magnetic flux flowing from the base, so that the magnetic flux density at the open end on the magnetic flux delivering side is also lower than that at the base. (see FIG. 3(a)).

FIG. 3 illustrates magnetic flux transmission paths.

FIG. 3(a) schematically shows a magnetic flux flow between the rotor and the stator yoke in the conventional clutch. FIG. 3(b) schematically shows a magnetic flux flow between a rotor and a stator yoke in a clutch according to the present invention which will be described later.

In FIG. 3(a), magnetic flux φ concentrates on the portions indicated at A and B and saturation is apt to occur in those portions by flowing much electric current in a coil.

Consequently, in the conventional telescopic type clutch comprising the rotor of a U-shaped longitudinal section and the stator yoke of a like section, the magnetic flux density distribution in each cylindrical portion is non-uniform and the magnetic flux transmission efficiency of the magnetic circuit is low.

### SUMMARY OF THE INVENTION

The present invention has been made in the light of the above problems and it is an object of the present invention to provide an electromagnetic clutch of a simple, compact and light-weight configuration, reduced in thickness, omitting unnecessary constituent elements and ensuring high efficiency.

For achieving the above-mentioned object the present invention adopts the following means.

(1) An electromagnetic clutch comprising a stator yoke, the stator yoke comprising a cylindrical portion with a slant inner surface and an annular base plate portion contiguous at an end thereof perpendicularly to one end of the cylindrical portion with the slant inner surface, a radial section cut from the central axis of the cylindrical portion with the slant inner surface being L-shaped, and a rotor, the rotor comprising an annular plate portion, a truncated inverse circular cone portion contiguous at an end thereof perpendicularly to an inner end of the annular plate portion and having a central circular through hole, and an outer cylindrical portion contiguous at an end thereof perpendicularly to an outer end of the annular plate portion, the rotor covering an upper end side of the cylindrical portion with the slant inner surface of the stator yoke and also covering an electromagnetic coil, the truncated inverse circular cone portion being disposed so as to be loosely fitted inside the cylindrical portion with the slant inner surface.
(2) An electromagnetic clutch according to the above (1), wherein the cylindrical portion with the slant inner surface and the truncated inverse circular cone portion are spaced a distance apart from each other so that respective facing surfaces permit transmission of magnetic flux therethrough and relative angular displacement is possible.
(3) An electromagnetic clutch according to the above (1) or (2), wherein the truncated inverse circular cone portion of the rotor and the slant inner surface inside the cylindrical portion of the stator yoke correspond respectively to bisected portions obtained by making an oblique cut in a thick-walled pipe as viewed from a longitudinal section thereof.

### (4) An electromagnetic clutch according to any one of the above (1) to (3), wherein the rotor is fixed to a shaft, the shaft being supported by the stator yoke rotatably through a bearing.

### (5) An electromagnetic clutch according to any one of the above (1) to (3), wherein the rotor is supported by a shaft rotatably through a bearing, the shaft being supported by the stator yoke rotatably through a bearing.

(6) An electromagnetic clutch according to any one of the above (1) to (5), wherein the outer cylindrical portion and the annular base plate portion are disposed in such a manner that an inner surface of an open end of the outer cylindrical portion and an outer periphery surface of the annular base plate portion are opposed to each other.
(7) An electromagnetic clutch according to any one of the above (1) to (6), wherein cross-section areas of the truncated inverse circular cone portion, the cylindrical portion with the slant inner surface, as well as the outer cylindrical portion, is set in such a manner that, in connection with a section cut along a plane perpendicular to a rotational axis, the sum of a cross-section area of the truncated inverse circular cone portion of the rotor and a cross-section area of the cylindrical portion with a slant inner surface of the stator yoke is equal to a cross-section area of the outer cylindrical portion of the rotor.
(8) An electromagnetic clutch according to any one of the above (1) to (7), wherein the electromagnetic coil is disposed in contact with both the cylindrical portion with the slant inner surface and the annular base plate portion, the cylindrical portion with the slant inner surface and the annular base plate portion forming the L-shaped longitudinal section of the stator yoke.
(9) An electromagnetic clutch according to any one of the above (1) to (8), wherein the thickness of the outer periphery of the annular base plate portion of the stator yoke is made larger than that of the other portion of the annular base plate portion so as to increase the area of the outer periphery surface of the annular base plate portion opposed to the outer cylindrical portion of the rotor.

Thus, the yoke of the thin electromagnetic clutch according to the present invention comprises a rotor having a truncated inverse circular cone portion formed with a central circular through hole and a stator yoke having a cylindrical portion with a slant inner surface. Opposed surfaces of the truncated inverse circular cone portion of the rotor and the cylindrical portion with the slant inner surface of the stator yoke are truncated cone surfaces. The following effects are attained by this configuration.

The facing surface area of the rotor and that of the stator yoke become larger by an amount corresponding to the aforesaid truncated cone surfaces in comparison with the conventional cylindrical surfaces (by the difference between the length of a vertical line at an angle of 90° from a horizontal plane and that of an edge line running along a truncated cone surface laid down at a predetermined angle) and an axial facing surface area of the open end of the cylindrical portion of the stator yoke becomes smaller.

Consequently, most of the magnetic flux transfer between the truncated inverse circular cone portion of the rotor and the cylindrical portion of the stator yoke is performed at the facing surfaces of the two truncated cones and the magnetic flux passing the axial opposed surface of the open end of the cylindrical portion of the stator yoke is diminished (see FIG. 3(b)). Thus, the axial attractive force decreases and it is possible to make the clutch diameter small and reduce the size of the bearing which bears the axial attractive force. FIG. 3(b) schematically shows the flow of magnetic flux between the rotor and the stator yoke in the clutch of the present invention. It is seen that in FIG. 3(b) there is no such concentrated part of magnetic flux φ as shown in FIG. 3(a).

In connection with a section cut along a plane perpendicular to a rotational axis, the cross-section area of the truncated inverse circular cone portion of the rotor and that of the cylindrical portion of the stator yoke increase continuously from the open end to the base part in accordance with the amount of flowing magnetic flux, so that the magnetic flux density distribution becomes uniform, the magnetic resistance becomes low, and the efficiency of the magnetic circuit becomes higher than that of the conventional clutch wherein the stator yoke of a U-shaped longitudinal section and the rotor of a like section are combined in a telescopic fashion.

Since the truncated inverse circular cone portion is provided around the shaft, the load on the rotor can be borne by a support structure of a truncated inverse circular cone shape. Consequently, the support structure becomes strong and it is possible to suppress deformation of the rotor caused by imbalance torque provided from a drive source.

Since the electromagnetic coil is disposed in contact with both the cylindrical portion with the slant inner surface and the annular base plate portion, the portions of which form the L-shaped longitudinal section of the stator yoke, magnetic flux generated in the electromagnetic coil can be passed effectively through the cylindrical portion and the annular base plate portion of the stator yoke positioned closest to the electromagnetic coil.

The thickness of the truncated inverse circular cone portion is set larger than (as seen in the radial direction) that of the outer cylindrical portion of the rotor. The thickness of the cylindrical portion of the stator yoke which is combined with the truncated inverse circular cone portion to form a magnetic path is also large like the truncated inverse circular cone portion. Consequently, in connection with the section cut along a plane perpendicular to the rotational axis, the sum of the cross-section areas of the truncated inverse circular cone portion of the rotor and the cylindrical portion of the stator yoke can be made equal to the cross-section area of the outer cylindrical portion of the rotor, and it is possible to diminish the difference in magnetic flux density, diminish flowing of magnetic flux to unnecessary portions and make the magnetic flux act effectively. It can be said that the truncated inverse circular cone portion of the rotor and the cylindrical portion with the slant inner surface of the stator yoke correspond respectively to bisected portions obtained by making an oblique cut, as shown in the figure, in a thick-walled pipe as viewed from a longitudinal section thereof.

### BRIEF DESCRIPTION OF THE DRAWINGS

FIG. 1 is a longitudinal section view of an electromagnetic clutch of type 1 according to the present invention, showing an energized state of the clutch;

FIG. 2 is a longitudinal section view of an electromagnetic clutch of type 2 according to the present invention, showing an energized state of the clutch;

FIG. 3 illustrates magnetic flux transmission paths;

FIG. 4 is an explanatory diagram of magnetic flux transmission using a longitudinal section view of an inner cylindrical portion in an electromagnetic clutch of type 3 according to the present invention; and

FIG. 5 illustrates a relation among the cross-section areas of various portions in the present invention.

### DETAILED DESCRIPTION OF PREFERRED EMBODIMENTS

Embodiments of the present invention will be described in detail hereinunder with reference to the accompanying drawings. There are three types of thin electromagnetic clutches according to the present invention.

### First Embodiment

### (Type 1)

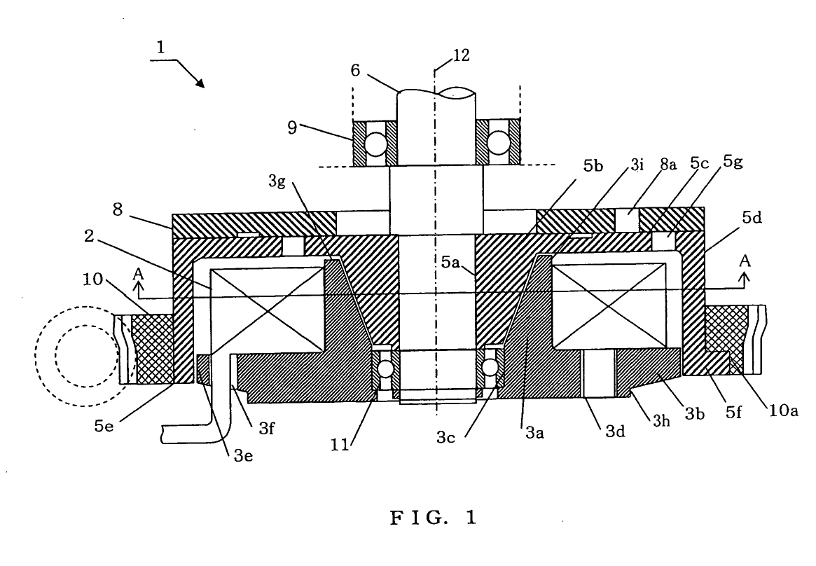

FIG. 1 is a longitudinal section view of an electromagnetic clutch of type 1 according to the present invention, showing an energized state of the clutch. The electromagnetic clutch of type 1, indicated with numeral 1, includes an electromagnetic coil 2, a stator yoke 3 of an L-shaped longitudinal section which accommodates the electromagnetic coil 2 therein, a rotor 5 provided centrally with a truncated inverse circular cone portion 5b, a shaft 6 adapted to rotate about a rotational axis 12, an armature 8, a large-diameter bearing 9 disposed on the armature 8 side of the shaft 6, a small-diameter bearing 11 which supports the shaft 6 with respect to the stator yoke 3, and a worm wheel 10 mounted on the rotor 5.

The electromagnetic coil 2 is accommodated within a coil bobbin (not shown) of a U-shaped section, has a square or rectangular longitudinal section and is formed in an annular shape when seen in the rotational axis direction. The electromagnetic coil 2 is fixed to the stator yoke 3 by caulking performed at several positions of an open end outside 3i of the cylindrical portion of the stator yoke 3.

The stator yoke 3 is formed of a magnetic metal material and a radial section thereof cut from the axis (coincident with the rotational axis 12 of the shaft 6) of the cylindrical portion of the stator yoke is formed in L shape so as to accommodate the electromagnetic coil 2, as shown in FIG. 1, and is formed in an annular shape when seen in the rotational axis direction. The L-shaped section comprises a cylindrical portion 3a with a slant inner surface and an annular base plate portion 3b contiguous at an end thereof perpendicularly to one end of the cylindrical portion 3a with the slant inner surface.

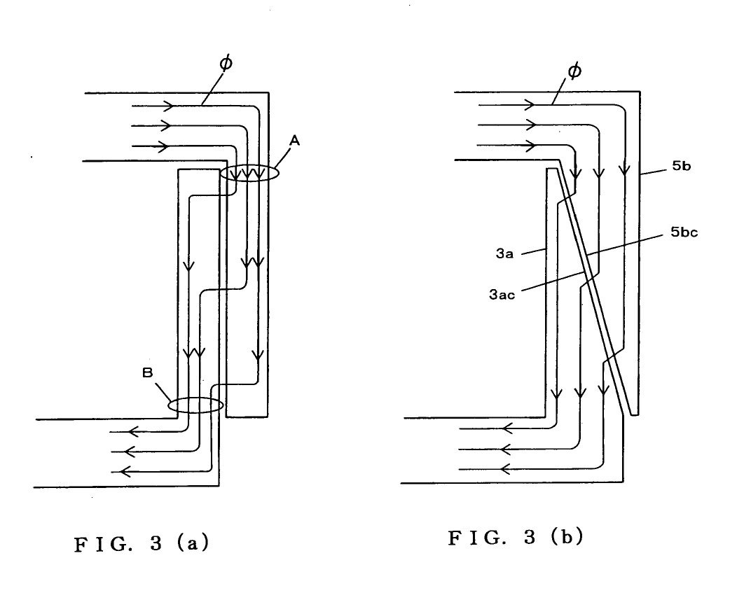

As shown in FIG. 3(b), the cylindrical portion 3a with the slant inner surface includes a slant surface 3ac as an inner surface whose diameter gradually decreases rectilinearly from the armature 8 side toward a small-diameter bearing mounting portion 3c. The cylindrical portion 3a supports the shaft 6 rotatably through the small-diameter bearing 11 mounted on an inner periphery surface of the cylindrical portion 3a. By forming the annular base plate portion 3b in such a manner that the thickness thereof becomes smaller toward its radial outer end, a radial sectional area thereof assumes an approximately constant value, a radial magnetic flux density becomes uniform, and the weight of the stator yoke 3 becomes light, whereby it is possible to effect saving of the material.

A draw-out hole 3f for a lead wire of the electromagnetic coil 2 is formed in the annular base plate portion 3b. Further, several tapped holes 3d for fixing the entire clutch to an object device to which the clutch is to be mounted, as well as a positioning cylindrical surface 3h, are formed in the annular base plate portion 3b. The stator yoke 3 with L-shaped section is free of any complicated morphological portion and is easy to manufacture.

The rotor 5 is formed of a magnetic metal material and is made up of a truncated inverse circular cone portion 5b having a central circular through hole 5a for the shaft, an annular plate portion 5c disposed annularly around the truncated inverse circular cone portion 5b as a central portion, and an outer cylindrical portion 5d contiguous perpendicularly to the outer periphery of the annular plate portion 5c. A projecting retaining portion 5f for retaining a driving force transfer part such as the worm wheel 10 is formed on an outer periphery surface of the outer cylindrical portion 5d. The truncated inverse circular cone portion 5b is sideways formed with a slant surface 5bc, the slant surface 5bc being formed in opposition to the slant surface 3ac as the inner surface of the cylindrical portion 3a so that the diameter thereof decreases rectilinearly in the same direction as the converging direction of the slant surface 3ac whose diameter decreases rectilinearly from the armature 8 side toward the small-diameter bearing mounting portion 3c.

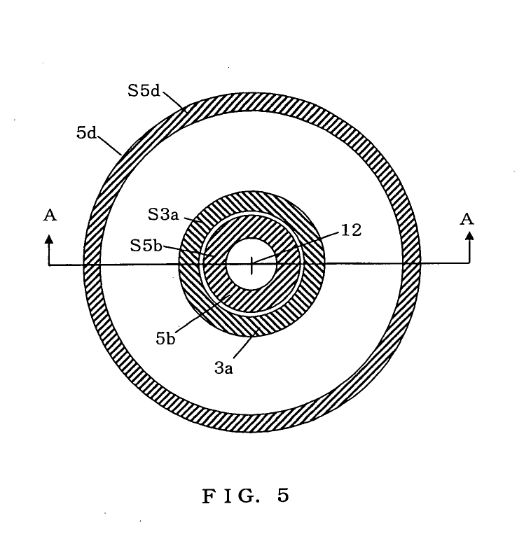

It can be said that the truncated inverse circular cone portion of the rotor and the cylindrical portion with the slant inner surface of the stator yoke correspond respectively to bisected portions obtained by making an oblique cut, as shown in the figure, in a thick-walled pipe as viewed from a longitudinal section thereof. The surfaces formed by the cut-in portion cause the outer cylindrical portion 5d and the annular base plate portion 3b to be disposed so that the inner periphery surface of the open end of the outer cylindrical portion 5d and the outer periphery surface of the annular base plate portion 3b confront each other. Since the outside diameter of the annular base plate portion 3b is several times larger than the average diameter of the conical surface of the cylindrical portion, the opposed areas become larger and the magnetic flux density does not become high. The thickness of the truncated inverse circular cone portion 5b is made large in comparison with the thickness (as seen in the radial direction) of the outer cylindrical portion 5d of the rotor 5. Like the truncated inverse circular cone portion 5b, the thickness of the cylindrical portion 3a with the slant inner surface of the stator yoke 3 which is combined with the truncated inverse circular cone portion 5b to form a magnetic path is also large. Consequently, in connection with a section cut along a plane perpendicular to the rotational axis 12, by setting the radial lengths of the portions concerned in such a manner that the sum of the cross-section areas of the truncated inverse circular cone portion 5b and the cylindrical portion 3a with the slant inner surface equals the cross-section area of the outer cylindrical portion 5d, it is possible to diminish the difference in magnetic flux density, diminish the extension of magnetic flux to unnecessary portions and make the magnetic flux act effectively. An example thereof will now be explained with reference to FIG. 5, which shows a cross-section view of the type 1 clutch cut along a plane perpendicular to the rotational axis, as shown using line A-A in FIG. 1.

In FIG. 5, from which the electromagnetic coil is omitted, given that the cross-section area of the cylindrical portion 3a with the slant inner surface of the stator yoke is S3a, the cross-section area of the truncated inverse circular cone portion 5b of the rotor is S5b, and the cross-section area of the outer cylindrical portion 5d of the rotor is S5d, the following equation should be satisfied,

S3a+S5b=S5d

For example, if the thickness of 5d is given and the thickness of the combined portion of 5b and 3a is to be determined, the inside diameter concerned is determined from the size of the shaft and that of the bearing, assuming that the gap between 5b and 3a is small, the outside diameter can be determined from the inside diameter and the thickness of 5d using the above equation, because the cross-section areas which satisfy the above equation are determined by these dimensions, then 5b and 3a are brought into oblique opposition to each other within the thickness.

The open side of rotor 5 is disposed opposite to the armature so as to accommodate the cylindrical portion 3a with the slant inner surface of the stator yoke 3 and also accommodate the electromagnetic coil 2 adjacent to the cylindrical portion 3a. Magnetic shielding portions 5g are formed by blanking in the annular plate portion 5c of the rotor 5 at positions corresponding to both inner and outer periphery sides of magnetic shielding portions 8a of the armature 8.

The small-diameter bearing 11 retained by the shaft 6 is disposed in abutment against a lower end of the truncated inverse circular cone portion 5b. The outer periphery surface of the outer cylindrical portion 5d is formed as a flat surface free of any concave and convex. The worm wheel 10 having for example a flat inner periphery surface and an outer periphery surface formed with worm teeth is fitted on the outer periphery surface of the outer cylindrical portion 5d. An inserting/positioning groove 10a corresponding to the retaining portion 5f is formed in the inner periphery surface of the worm wheel 10. When press-fitting the worm wheel 10 onto the outer periphery surface of the rotor 5, the fitting operation is performed while inserting the retaining portion 5f into the insertion/positioning groove 10a to prevent the worm wheel from dislodging. Driving force provided from a motor (not shown) is transmitted to the rotor 5 through the worm wheel 10 and the shaft 6 rotates together with the rotor 5.

The armature 8 is formed of a magnetic material such as iron, and is disposed in opposition to the frictional surface of the rotor 5, between which a distance is spaced. Formed in the shape like a ring, the armature 8 is made of a flat plate, and has a magnetic shielding slit at an intermediate position thereof formed by blanking. Its frictional surface for contact with the rotor 5 is treated with nitriding to improve the wearability. With several arms of a pulley (not shown) disposed at an upper position and adapted to be loosely fitted in the slit, the armature 8 is kept incapable of performing a relative angular displacement and capable of performing an axial relative displacement with respect to the pulley. Upon energization of the electromagnetic coil 2, the armature 8 is attracted to the rotor 5 and the driving force acting at this instant is transferred to the armature 8. Separating from the rotor 5 and reverting to the original position of the armature 8 are performed by the action of a spring connected to the pulley. Mounted on the shaft 6, the pulley can perform a relative angular displacement and cannot perform an axial relative displacement with respect to the shaft 6.

The shaft 6 is supported through the large-diameter bearing 9 by a housing indicated with dotted lines at a position above the armature 8. Since the shaft 6 is supported at both ends of the electromagnetic mechanism, there is little vibration of the shaft.

Since the electromagnetic coil 2 is disposed in contact with both the cylindrical portion 3a with the slant inner surface and the annular base plate portion 3b of the stator yoke 3 having an L-shaped longitudinal section, the magnetic flux generated in the electromagnetic coil 2 can be allowed to pass effectively through the cylindrical portion 3a and the annular base plate portion 3b of the stator yoke 3 positioned closest to the electromagnetic coil 2. In the case of the cylindrical portion 3a with the slant inner surface, magnetic resistance becomes low because the magnetic flux density distribution is uniform. Moreover, since the longitudinal section of the stator yoke 3 is L-shaped, the magnetic flux generated by the electromagnetic coil 2 of a quadrangular section (including square and rectangle) can be effectively utilized.

The truncated inverse circular cone portion 5b of the rotor 5 and the cylindrical portion 3a with the slant inner surface of the stator yoke 3 confront each other through the respective slant surfaces. Facing surface areas of the rotor 5 and that of the stator yoke 3 become larger by an amount corresponding to the aforesaid truncated cone surfaces in comparison with the conventional cylindrical surfaces (by the difference between the length of a vertical line at an angle of 90° from a horizontal plane and that of an edge line running along a truncated cone surface laid down at a predetermined angle) and an axial surface 3g of the open end of the cylindrical portion of the stator yoke 3 becomes smaller. Consequently, most of the magnetic flux transfer between the truncated inverse circular cone portion of the rotor 5 and the cylindrical portion of the stator yoke 3 is performed at the facing surfaces of the two truncated cones and the magnetic flux passing the axial opposed surface 3g of the open end of the cylindrical portion of the stator yoke 3 is diminished. Thus, the axial attractive force decreases and it is possible to make the clutch diameter small and reduce the size of the bearing 11 which bears the axial attractive force of the clutch.

The thickness of the truncated inverse circular cone portion 5b is made larger than the thickness (as seen in the radial direction) of the outer cylindrical portion 5d of the rotor 5. The thickness of the cylindrical portion 3a with the slant inner surface of the stator yoke 3 which is combined with the truncated inverse circular cone portion 5b to form a magnetic path is also made large like the truncated inverse circular cone portion 5b. As a result, in connection with a section cut along a plane perpendicular to the shaft 6, the sum of the cross-section areas of the truncated inverse circular cone portion 5b of the rotor 5 and the cylindrical portion 3a with the slant inner surface of the stator yoke 3 is made equal to the cross-section area of the outer cylindrical portion and hence it is possible to diminish the difference in magnetic flux density, diminish the extension of magnetic flux to unnecessary portions and make the magnetic flux act effectively.

When the electromagnetic coil 2 is not energized, input torque from the outer periphery side of the rotor 5 causes only the rotor 5 and the shaft 6 to rotate. When the electromagnetic coil 2 is energized, the armature 8 is attracted to the rotor 5 and causes the pulley (not shown) disposed in an upper position to rotate together with the rotor 5, providing an output.

### (Effects of First Embodiment)

(1) By making the opposition surfaces of the inner cylindrical portion of the rotor 5 and the inner cylindrical portion of the stator yoke 3 in the form of circular cone surfaces, in comparison with the conventional cylindrical surfaces, the facing surface area becomes larger and the area of the axial opposed surface 3g of the open end of the cylindrical portion of the stator yoke 3 becomes smaller. As to the influence on magnetic characteristics of the clutch, most of the magnetic flux transfer between the truncated inverse circular cone portion 5b of the rotor 5 and the cylindrical portion 3a with the slant inner surface of the stator yoke 3 is performed at the facing surfaces of the two truncated cone, the magnetic flux passing the axial opposed surface 3g of the open end of the cylindrical portion 3a with the slant inner surface of the stator yoke 3 is diminished and the axial attractive force decreases. As a result, it is possible to make the clutch diameter small, reduce the thickness of the clutch and reduce the size of the bearing which bears the axial attractive force.
(2) By changing the way of assembly between the rotor 5 and the inner cylindrical portion of the stator yoke 3 from the conventional cylindrical body telescopic type into the truncated cone telescopic type, in connection with a section cut along a plane perpendicular to the shaft 6 and in various positions from the open end to the base part, the cross-section area of either of inner cylindrical bodies increases (decreases) continuously in accordance with increase (decrease) of the amount of magnetic flux flowing therein. As to the influence on magnetic characteristics of the clutch, the magnetic flux density distribution in either of inner cylindrical bodies becomes uniform, magnetic resistance becomes lower and the efficiency of the magnetic circuit becomes higher. As a result, it is possible to reduce the clutch size.
(3) The stator yoke 3 having an L-shaped longitudinal section not only acts as part of the magnetic circuit but also plays a part in fixing and positioning the entire clutch, fixing the electromagnetic coil, and supporting the shaft 6 through a bearing. Besides, the stator yoke 3 does not have any complicated morphological portion and is easy to manufacture. The rotor 5 not only acts as part of the magnetic circuit but also plays a part in receiving the input torque. The inner cylindrical portion having an truncated inverse circular cone section of the rotor 5 is of high efficiency and is of high resistant to deformation caused by an imbalance input torque. As a result, the structure of the clutch is simple, the number of parts is small, and the clutch is easy to manufacture and highly reliable.

### Second Embodiment

### (Type 2)

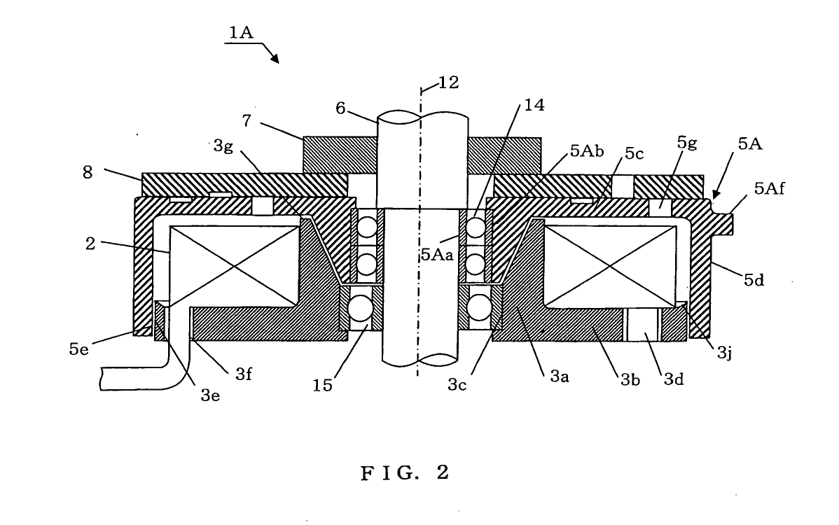

FIG. 2 is a longitudinal section view of an electromagnetic clutch of type 2 according to the present invention, showing an energized state of the clutch. The configuration of the type 2 electromagnetic clutch is basically different from that of the type 1 electromagnetic clutch both in point of the configuration for journaling the rotor 5 and the armature 8 on the shaft 6, and in point of a modified annular plate of the stator yoke 3. As to other constructional points, the same names and constituent elements of the same names as in the first embodiment have the same configurations, functions and effects as in the first embodiment, so those in the first embodiment are here applied and explanations thereof will be omitted.

In the electromagnetic clutch of type 2, indicated with numeral 1A, a rotor 5A is supported on a shaft 6 through two small-diameter bearings 14 and the shaft 6 is supported by a stator yoke 3 through a large-diameter bearing 15. An armature 8 is mounted on the shaft 6 through a hub 7 in such a manner that they are relatively displaceable in axial direction but no relative angular displacement can be performed.

The rotor 5A is made up of a truncated inverse circular cone portion 5Ab having a central circular through hole 5Aa for both the shaft 6 and the small-diameter bearings 14, an annular plate portion 5c disposed annularly around the truncated inverse circular cone portion 5Ab as the central portion, and an outer cylindrical portion 5d contiguous perpendicularly to the outer periphery of the annular plate portion 5c. A projecting retaining portion 5Af for retaining a driving force transfer part such as a worm wheel 10 is formed on an outer periphery surface of the outer cylindrical portion 5d. The two small-diameter bearings 14 are disposed on an inner wall of the central circular through hole 5Aa of the truncated inverse circular cone portion 5Ab and they are locked to the shaft 6.

The rotor 5A and the stator yoke 3 are positioned by the bearings 14 and 15 in such a manner that the surface of the truncated inverse circular cone portion 5Ab and a surface of the cylindrical portion 3a with the slant inner surface are spaced with a predetermined distance from each other. The bearing 15 provided in the stator yoke 3 is large in diameter and therefore, with only the large-diameter bearing 15, it is possible to support the shaft 6 with the rotor 5A mounted thereon. Thus, unlike the clutch of type 1, it is possible to eliminate the need of disposing another bearing at a position spaced from the large-diameter bearing.

For simplifying the shape, the bottom of an annular base plate portion 3b of the stator yoke 3 is made flat. Moreover, for further increasing the opposition area with respect to the outer cylindrical portion 5d of the rotor 5A to further diminish the axial attractive force with the rotor 5A, a projection 3j is formed on top of the outer periphery surface of the annular base plate portion 3b. Thus, the shape of the stator yoke 3 becomes simple, so that it can be formed for example by a single forging except a bearing mounting portion 3c and tapped holes 3d, consequently, to reduce the manufacturing cost is possible.

When the electromagnetic coil 2 is not energized, input torque from the outer periphery side of the rotor 5 causes the rotor 5 alone to rotate. When the electromagnetic coil 2 is energized, the armature 8 is attracted to the rotor 5 and drives the shaft 6 to rotate together with the rotor 5 through the hub 7, providing an output. Separating from the rotor 5 and reverting to the original position of the armature 8 are performed by spring action of the hub.

As to the structure of the annular base plate portion, in the electromagnetic clutch of type 2 wherein the rotor and the shaft are rotatable with respect to each other, there may be adopted such a configuration as that described above in connection with the electromagnetic clutch of type 1 wherein the thickness of the annular base plate portion 3b becomes smaller toward the radial outer end, or conversely, in the electromagnetic clutch of type 1 wherein the rotor and the shaft always rotate in one piece with each other, there may be adopted such a configuration as described above in connection with type 2 wherein the bottom of the annular base plate portion 3b is made flat.

### (Effects of Second Embodiment)

According to the second embodiment there are obtained the following effects in addition to the effects obtained in the first embodiment. Since the two small-diameter bearings 14 are disposed between the rotor 5A and the shaft 6, no bearing is disposed outside the armature 8 like type 1, so that the manufacturing cost of the stator yoke 3 is reduced. In the second embodiment, moreover, since only the rotor 5A can be rotated through the bearing 14 without restraining the shaft 6, the shaft 6 is not rotated at all times like type 1. On the other hand, since three bearings are mounted to a clutch body, the thickness and the diameter of the clutch body somewhat increases as compared with the first embodiment.

The first and second embodiments can be adopted selectively according to a demand in the place where the present invention is applied.

### Third Embodiment

### (Type 3)

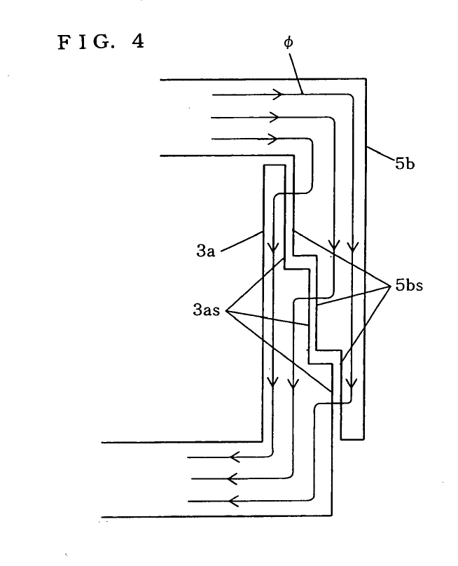

FIG. 4 is an explanatory diagram of magnetic flux transmission, using a longitudinal section view of an inner cylindrical portion of an electromagnetic clutch of type 3 according to the present invention.

A cylindrical portion 3a with a stepped surface 3as as an inner surface whose diameter decreases (the radial thickness of the cylindrical portion 3a increases) stepwise from an armature 8 side toward a bearing mounting portion 3c.

An truncated inverse circular cone portion 5b is sideways provided with a stepped surface 5bs whose diameter decreases stepwise from the armature 8 side toward the bearing mounting portion 3c, the stepped surface 5bs being provided in opposition to the stepped surface 3as as the inner surface of the cylindrical portion 3a the diameter of which stepped surface 3as decreases stepwise in the same direction as the decreasing direction of the above diameter.

As shown in the first and third embodiments, the “slant inner surface” includes both a slant surface whose diameter decreases rectilinearly and a stepped surface whose diameter decreases stepwise.

A magnetic path formed by the cylindrical portion 3a with the stepped inner surface and the truncated inverse circular cone portion 5b in FIG. 4 includes no concentrated portion of magnetic flux, as shown in the figure, permitting magnetic flux to pass through the two along a radial magnetic path, so that there no longer is any place on which is exerted a vertical attractive force between the rotor 5 and the stator yoke 3, and the value of saturated magnetic flux can be made high.

Consequently, like the slant surface of a rectilinearly decreasing diameter in the first embodiment, the stepped surface of a stepwise decreasing diameter in the third embodiment includes no concentrated place of magnetic flux, permitting magnetic flux to pass through both stepped surfaces along a radial magnetic path.

1. An electromagnetic clutch comprising:
a stator yoke, said stator yoke comprising a cylindrical portion with a slant inner surface and an annular base plate portion contiguous at an end thereof perpendicularly to one end of said cylindrical portion with the slant inner surface, a radial section cut from the central axis of said cylindrical portion with the slant inner surface being L-shaped; and
a rotor, said rotor comprising an annular plate portion, a truncated inverse circular cone portion contiguous at an end thereof perpendicularly to an inner end of said annular plate portion and having a central circular through hole, and an outer cylindrical portion contiguous at an end thereof perpendicularly to an outer end of said annular plate portion, said rotor covering an upper end side of said cylindrical portion with the slant inner surface of said stator yoke and also covering an electromagnetic coil, said truncated inverse circular cone portion being disposed so as to be loosely fitted inside said cylindrical portion with the slant inner surface.

2. An electromagnetic clutch according to claim 1, wherein said cylindrical portion with the slant inner surface and said truncated inverse circular cone portion are spaced a distance apart from each other so that respective facing surfaces permit transmission of magnetic flux therethrough and relative angular displacement is capable.

3. An electromagnetic clutch according to claim 1 wherein said truncated inverse circular cone portion of said rotor and said slant inner surface inside said cylindrical portion of said stator yoke correspond respectively to bisected portions obtained by making an oblique cut in a thick-walled pipe as viewed from a longitudinal section thereof.

4. An electromagnetic clutch according to claim 1, wherein said rotor is fixed to a shaft, said shaft being supported by said stator yoke rotatably through a bearing.

5. An electromagnetic clutch according to claim 1, wherein said rotor is supported by a shaft rotatably through a bearing, said shaft being supported by said stator yoke rotatably through a bearing.

6. An electromagnetic clutch according to claim 1, wherein said outer cylindrical portion and said annular base plate portion are disposed in such a manner than an inner surface of an open end of said outer cylindrical portion and an outer periphery surface of said annular base plate portion are opposed to each other.

7. An electromagnetic clutch according to claim 1, wherein cross-section areas of said truncated inverse circular cone portion, said cylindrical portion with the slant inner surface, as well as said outer cylindrical portion, are set in such a manner that, in connection with a section cut along a plane perpendicular to a rotational axis, the sum of a cross-section area of said truncated inverse circular cone portion of said rotor and a cross-section area of said cylindrical portion with a slant inner surface of said stator yoke is equal to a cross-section area of said outer cylindrical portion of said rotor.

8. An electromagnetic clutch according to claim 1, wherein said electromagnetic coil is disposed in contact with both said cylindrical portion with the slant inner surface and said annular base plate portion, said cylindrical portion with the slant inner surface and said annular base plate portion forming the L-shaped longitudinal section of said stator yoke.

9. An electromagnetic clutch according to claim 1, wherein the thickness of the outer periphery of said annular base plate portion of said stator yoke is made larger than that of the other portion of the annular base plate portion so as to increase the area of the outer periphery surface of the annular base plate portion opposed to said outer cylindrical portion of said rotor.

10. An electromagnetic clutch according to claim 2, wherein said truncated inverse circular cone portion of said rotor and said slant inner surface inside said cylindrical portion of said stator yoke correspond respectively to bisected portions obtained by making an oblique cut in a thick-walled pipe as viewed from a longitudinal section thereof.

11. An electromagnetic clutch according to claim 10, wherein said rotor is fixed to a shaft, said shaft being supported by said stator yoke rotatably through a bearing.

12. An electromagnetic clutch according to claim 3, wherein said rotor is fixed to a shaft, said shaft being supported by said stator yoke rotatably through a bearing.

13. An electromagnetic clutch according to claim 2, wherein said outer cylindrical portion and said annular base plate portion are disposed in such a manner than an inner surface of an open end of said outer cylindrical portion and an outer periphery surface of said annular base plate portion are opposed to each other.

14. An electromagnetic clutch according to claim 3, wherein said outer cylindrical portion and said annular base plate portion are disposed in such a manner than an inner surface of an open end of said outer cylindrical portion and an outer periphery surface of said annular base plate portion are opposed to each other.

15. An electromagnetic clutch according to claim 4, wherein said outer cylindrical portion and said annular base plate portion are disposed in such a manner than an inner surface of an open end of said outer cylindrical portion and an outer periphery surface of said annular base plate portion are opposed to each other.

16. An electromagnetic clutch according to claim 2, wherein cross-section areas of said truncated inverse circular cone portion, said cylindrical portion with the slant inner surface, as well as said outer cylindrical portion, are set in such a manner that, in connection with a section cut along a plane perpendicular to a rotational axis, the sum of a cross-section area of said truncated inverse circular cone portion of said rotor and a cross-section area of said cylindrical portion with a slant inner surface of said stator yoke is equal to a cross-section area of said outer cylindrical portion of said rotor.

17. An electromagnetic clutch according to claim 3, wherein cross-section areas of said truncated inverse circular cone portion, said cylindrical portion with the slant inner surface, as well as said outer cylindrical portion, are set in such a manner that, in connection with a section cut along a plane perpendicular to a rotational axis, the sum of a cross-section area of said truncated inverse circular cone portion of said rotor and a cross-section area of said cylindrical portion with a slant inner surface of said stator yoke is equal to a cross-section area of said outer cylindrical portion of said rotor.

18. An electromagnetic clutch according to claim 4, wherein cross-section areas of said truncated inverse circular cone portion, said cylindrical portion with the slant inner surface, as well as said outer cylindrical portion, are set in such a manner that, in connection with a section cut along a plane perpendicular to a rotational axis, the sum of a cross-section area of said truncated inverse circular cone portion of said rotor and a cross-section area of said cylindrical portion with a slant inner surface of said stator yoke is equal to a cross-section area of said outer cylindrical portion of said rotor.

19. An electromagnetic clutch according to claim 6, wherein cross-section areas of said truncated inverse circular cone portion, said cylindrical portion with the slant inner surface, as well as said outer cylindrical portion, are set in such a manner that, in connection with a section cut along a plane perpendicular to a rotational axis, the sum of a cross-section area of said truncated inverse circular cone portion of said rotor and a cross-section area of said cylindrical portion with a slant inner surface of said stator yoke is equal to a cross-section area of said outer cylindrical portion of said rotor.

20. An electromagnetic clutch according to claim 2, wherein said electromagnetic coil is disposed in contact with both said cylindrical portion with the slant inner surface and said annular base plate portion, said cylindrical portion with the slant inner surface and said annular base plate portion forming the L-shaped longitudinal section of said stator yoke.
